(19) United States
(12) Patent Application Publication
(10) Pub. No.: US 2009/0207179 A1
(43) Pub. Date: Aug. 20, 2009

(54) PARALLEL PROCESSING METHOD FOR SYNTHESIZING AN IMAGE WITH MULTI-VIEW IMAGES

(75) Inventors: Jen-Tse Huang, Taipei County (TW); Kai-Che Liu, Kaohsiung City (TW); Hong-Zeng Yeh, Taipei County (TW); Fu-Chiang Jan, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/168,926

(22) Filed: Jul. 8, 2008

(30) Foreign Application Priority Data
Feb. 20, 2008 (TW) 97105930

(51) Int. Cl. G06F 15/80

(52) U.S. Cl. 345/505

(57) ABSTRACT

A parallel processing method for synthesizing multi-view images is provided, which may parallel process at least a potion of the following steps. First, multiple reference images are input, wherein each reference image is correspondingly taken from a reference viewing angle. Next, an intended synthesized image corresponding to a viewpoint and an intended viewing angle is determined. Next, the intended synthesized image is divided to obtain multiple meshes and multiple vertices of the meshes, wherein the vertices are divided into several vertex groups, and each vertex and the viewpoint form a view direction. Next, the view direction is referenced to find several near-by images from the reference images for synthesizing an image of a novel viewing angle. After the foregoing actions are totally or partially processed according to the parallel processing mechanism, separate results are combined for use in a next processing stage.

### CROSS-REFERENCE TO RELATED APPLICATION

This application claims the priority benefit of Taiwan application serial no. 97105930, filed on Feb. 20, 2008. The entirety of the above-mentioned patent application is hereby incorporated by reference herein and made a part of specification.

### BACKGROUND OF THE INVENTION

1. Field of the Invention

The present invention relates to a virtual imaging technique based on a parallel processing method for synthesizing multi-view images.

2. Description of Related Art

Generally, when an actual scene is captured by a camera, images thereof assumed to be captured from other viewing angles cannot be deduced accurately. If the images of different viewing angles are required to be accurately deduced, conventionally, such images may be synthesized according to images captured from near-by viewing angles.

A complete multi-view image video system includes a plurality of processing stages. FIG. 1 is a flowchart illustrating an image processing method of a conventional multi-view image/video system. Referring to FIG. 1, the image processing method includes image video capturing of step 100, image correction of step 102, multi-view video coding (MVC) of step 104, multi-view video decoding of step 106, virtual view synthesizing of step 108 including view generation/synthesis/rendering/interpolation etc., and image displaying of step 110, by which a synthesized image is displayed on a displaying platform.

Though some conventional computer vision techniques are provided to obtain two-dimensional (2D) images with different viewing angles, since a calculation thereof is too complicated, processing efficiency thereof is relatively low. Therefore, the conventional image synthesis technique still requires to be developed.

### SUMMARY OF THE INVENTION

The present invention is directed to a parallel processing method for synthesizing multi-view images, by which based on a parallel processing mechanism, a portion of or the whole image synthesis processes are parallel processed.

The present invention provides a parallel processing method for synthesizing multi-view images. The method is as follows. First, multiple reference images are input, wherein each reference image is correspondingly taken from a reference viewing angle. Next, an intended synthesized image corresponding to a viewpoint and an intended viewing angle is determined. Next, the intended synthesized image is divided to obtain a plurality of meshes and a plurality of vertices, of the meshes, wherein the vertices are divided into several vertex groups. Next, scene depths of corresponding objects of the vertex groups are reconstructed. Next, a corresponding relation of near-by captured images is found based on the depths of the vertex groups, so as to synthesize the image.

For example, as shown in FIG. 15, steps of synthesizing the image may be simultaneously calculated based on a plurality of operational cores, and finally calculation results are combined to form a new image. The present invention also provides a plurality of parallel dividing methods and mechanisms thereof to further implement the parallel processing effect. Wherein, at least one of the aforementioned steps is performed based on the parallel processing method.

Synthesizing of the images includes a plurality of modes. For example, in a first mode, a conventional interpolation method is not applied, so as to reserve edges of the image for increasing a clarity effect, and in a second mode, a weight-based image interpolation method is applied, so as to synthesize the new image based on an average approach for providing a relatively better visual effect.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a flowchart illustrating an image processing method of a conventional multi-view image video system.

FIG. 2 is a flowchart illustrating an algorithm applied to an embodiment of the present invention.

FIG. 3 is a schematic diagram illustrating an interpolation mechanism for image synthesizing according to an embodiment of the present invention.

FIG. 4 is a schematic diagram illustrating an interpolation mechanism applied to an embodiment of the present invention.

FIG. 5 is a schematic diagram illustrating a relation mechanism between a 2D image and a 3D image with depths information.

FIG. 6 is a schematic diagram illustrating a mesh dividing mechanism according to an embodiment of the present invention.

FIG. 7 is a schematic diagram illustrating a mechanism of selecting a ROI according to an embodiment of the present invention.

FIG. 8 is a schematic diagram illustrating a mechanism of finding near-by reference images of each vertex according to an embodiment of the present invention.

FIG. 9 is a schematic diagram illustrating angle parameters according to an embodiment of the present invention, wherein a viewpoint 210 observes a p point of an object surface.

FIGS. 10A˜10C are schematic diagrams illustrating some inconsistent circumstances.

FIG. 11 is a schematic diagram illustrating a mechanism of finding near-by reference images.

FIG. 12 is a schematic diagram illustrating a mechanism of determining a vertex depth according to an embodiment of the present invention.

FIG. 13 is a schematic diagram illustrating a memory space distribution based on a parallel processing method according to an embodiment of the present invention.

FIG. 14 is a schematic diagram illustrating a memory space distribution based on a parallel processing method according to an embodiment of the present invention.

FIG. 15 is a schematic diagram illustrating a parallel processing mechanism applying four cores according to an embodiment of the present invention.

FIG. 16 is a schematic diagram illustrating a parallel processing mechanism applying four cores for processing different vertex densities, according to an embodiment of the present invention.

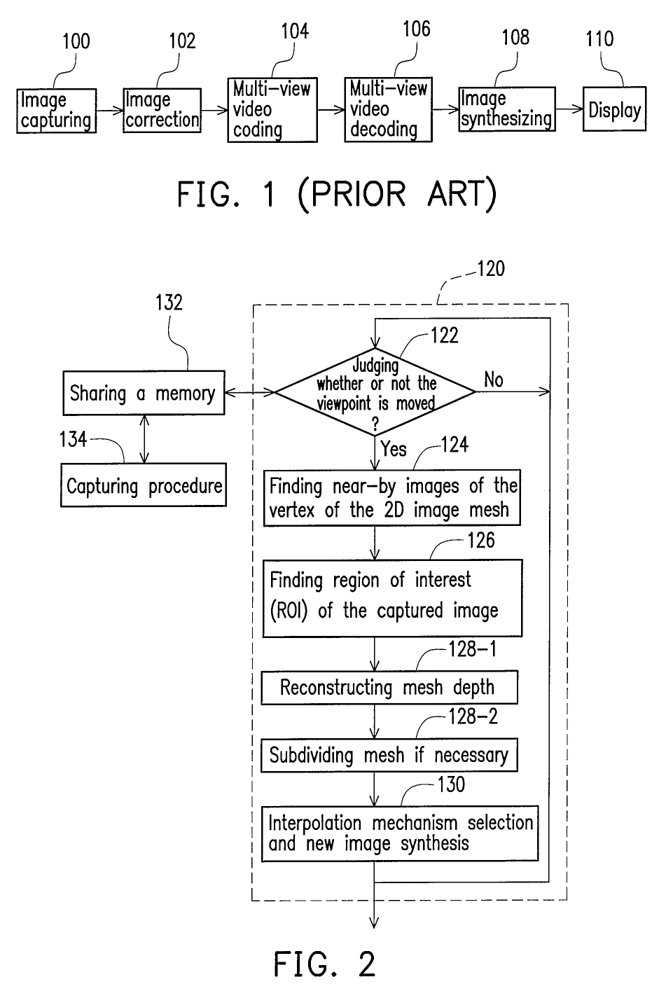

### DESCRIPTION OF EMBODIMENTS

Embodiments are provided below for describing the present invention, though the present invention is not limited thereto, and the presented embodiments may also be properly combined with each other.

Research and development of hardware and software based on a parallel processing technique are developed recently, for example, some computer systems allow CPUs thereof having multiple cores for processing. Mover, general purpose graphics processing units (GPGPU) or signal processor such as IBM cell, also provide the ability of parallel processing. Based on the parallel processing technique, the present invention provides an image synthesizing method based on the parallel processing, in which the steps requiring a large amount of calculations may be executed based on the parallel processing method, so as to achieve an improved processing rate.

The present invention provides a multi-view images synthesizing technique, and in coordination of the parallel processing method, the processing rate may be effectively improved. In the multi-view images synthesizing technique, a depth-based interpolation is a 2.5D spatial viewing angle synthesizing technique based on an image-based rendering concept and a model-based rendering concept, and input information thereof are still images or multiple videos. An algorithm thereof is based on a plane sweeping method, by which light rays penetrating through each vertex of a 2D image mesh sweeps different depth planes within a space, so as to construct the most suitable depth information. FIG. 2 is a flowchart illustrating an algorithm applied by the present invention. Referring to FIG. 2, according to the algorithm 120, in step 122, whether or not a viewpoint is moved is judged, wherein a calculation thereof is performed based on a plurality of reference images corresponding to different viewing angles captured by a capturing procedure 134 via a sharing memory 132. The calculation of view synthesis will always be performed no matter whether the viewpoint moves or not. In step 124, a virtual 2D image to be generated is divided into a plurality of meshes, and a plurality of near-by reference images is respectively found according to a position and a view direction of each vertex of each of the meshes. In step 126, a region of interest (ROI) of the captured images is found. Next, in step 128, a scene depth of each vertex of the virtual 2D image to be generated is constructed. Finally, in step 130, the image is synthesized.

FIG. 5 is a schematic diagram illustrating a relation mechanism between a 2D image and a 3D image with depths information. Referring to FIG. 5, according to a general image processing technique, meshes of a 2D image 212 captured corresponding to a viewpoint 210 may correspond to meshes of a 3D image 214 with the depths information, and variation of the depths may be described with a sphere surface. For example, the 2D image 212 is divided to obtain a plurality of relatively great meshes, wherein shapes of the meshes are, for example triangles, though the present invention is not limited thereto. Since depths variation on the edge of the sphere is relatively great, dividing density of the meshes requires to be relatively fine, so as to reveal variation of the depths. FIG. 6 is a schematic diagram illustrating a mesh subdivision mechanism according to an embodiment of the present invention. Referring to FIG. 6, the vertices of the meshes of the 3D image 214 have different calculated depths dm1, dm2 and dm3. If depths variation is greater than a predetermined value, it indicates that variation of spatial depths of an object is relatively great, and the meshes are required to be finely divided. For example, the mesh is further divided into four triangle meshes 216a-216d, so as to reveal the variation of the depths.

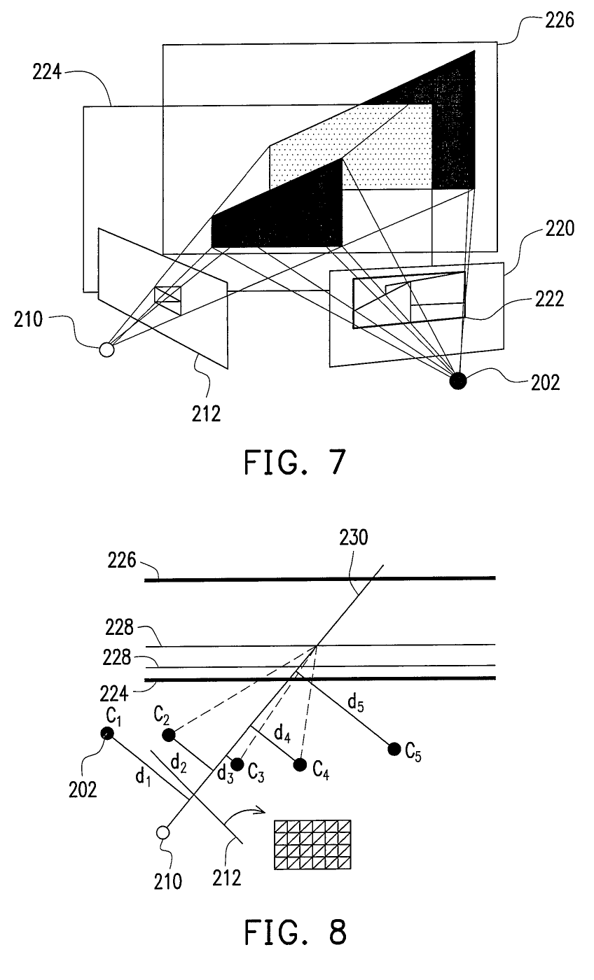

In the following content, how to obtain the depths of the vertices, conditions of further subdividing and selecting of the ROI are described. First, a mechanism of selecting the ROI is described. FIG. 7 is a schematic diagram illustrating a mechanism of selecting a ROI according to an embodiment of the present invention. Referring to FIG. 7, selecting of the ROI 222 is not absolutely necessary, considering a required calculation quantum, image blocks of the ROI may be selected, and depth and interpolation calculation may be only performed to the image blocks of the ROI, so as to reduce the calculation quantum. Generally, it is assumed that the virtual 2D image to be generated has a minimum depth and a maximum depth. The virtual 2D image 212 to be generated is divided to obtain the meshes, and in allusion to the vertices of the meshes and the viewpoint 210, a set maximum depth plane 226 and a minimum depth plane 224 may be projected to another image 220, which may correspond to a reference image 220 captured by a camera 202. A position where the maximum depth plane 226 is projected on the image 220 has a distribution area, and a position where the minimum depth plane 224 is projected on the image 220 has another distribution area. The two areas may be combined to form the ROI block. As to a selection mechanism of the ROI block, the ROI block may be circled by an epipole line known by those skilled in the art.

Next, how to find near-by reference images of each vertex is described. FIG. 8 is a schematic diagram illustrating a mechanism of finding near-by reference images of each vertex according to an embodiment of the present invention. Referring to FIG. 8, there are M predetermined depth planes 228 set between the minimum depth dₘᵢₙ plane 224 and the maximum depth dₘₐₓ plane 226. If the maximum depth is represented by dₘₐₓ, and the minimum depth is represented by dₘᵢₙ, a m-th depth dₘ 228 then may be represented by a following mathematic equation:

$${d}_{m} = \frac{1}{\frac{1}{{d}_{max}} + \frac{m}{M - 1} ( \frac{1}{{d}_{min}} - \frac{1}{{d}_{max}} )} .$$

Wherein m is a value from 0 to M-1. Intervals of the depth dₘ 228 are not equidistant, but varied in an increasing approach, so as to facilitate finding of suitable depths in regions with relatively great depths.

The 2D image 212 is divided to obtain the plurality of meshes, and each mesh has the plurality of vertices. Each of the vertices and the viewpoint 210 form a view direction 230. For example, the near-by reference images corresponding to the view direction 230 may be find according to the view direction 230 and the viewing angle of the camera 202 used for capturing the reference images. The reference images may have a sequence of C3, C2, C4, C1, C5 . . . according to near-by degrees or distance thereof, and a predetermined number of reference images may be selected from the reference images to function as the near-by reference images.

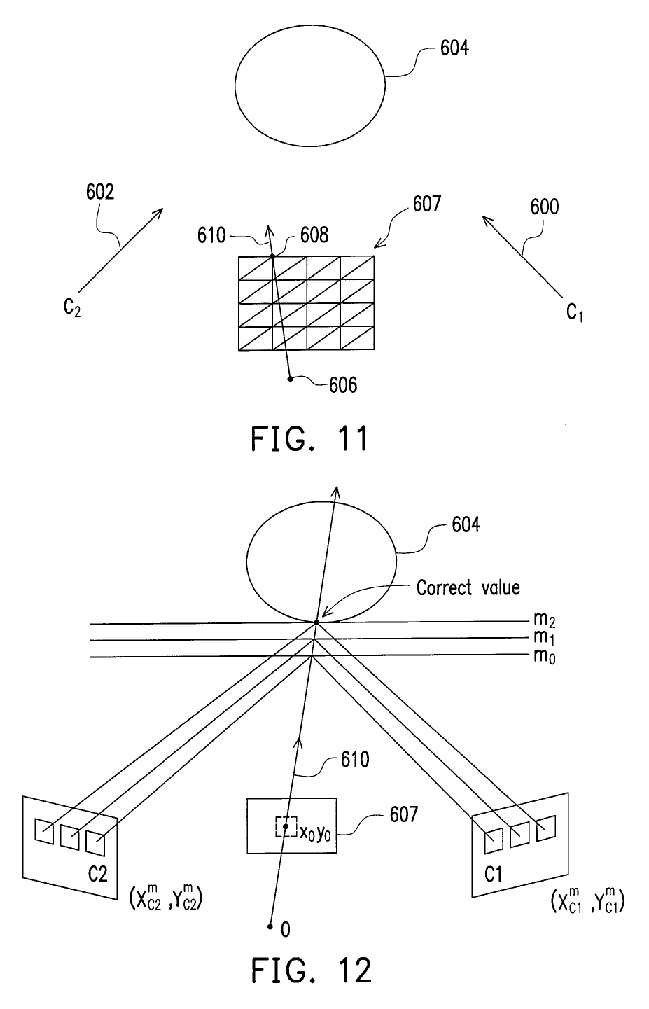

Moreover, referring to FIG. 11, FIG. 11 is a schematic diagram illustrating a mechanism of finding near-by reference images. By which the near-by reference images are found according to another method. Each vertex 608 on the 2D virtual image 607 and a viewpoint 606 form a view direction 610 for observing an object 604. A group of near-by reference images is found while taking the view direction 610 as a reference direction. The number of the near-by reference images is multiple, and generally four near-by reference images are obtained for a follow-up interpolation calculation. A view direction 600 of a camera C₁ or a view direction 602 of a camera C₂ forms an angle with the view direction 610. By analysing a size of the angle, the near-by cameras then may be obtained. However, besides the angle parameter, other factors may also be taken into consideration, which is determined according to different designs thereof. Each of the vertices has a corresponding group of near-by reference images.

Referring to FIG. 8 again, there are different depth planes 228 set between the maximum depth plane 226 and the minimum depth plane 224, in which there is a depth being the closest to an actual depth, which is the suitable depth to be determined corresponding to each vertex. In the following content, how to determine the suitable depth of each vertex is described. FIG. 12 is a schematic diagram illustrating a mechanism of determining a vertex depth according to an embodiment of the present invention. Referring to FIG. 12, assuming there are three depth planes m0, m1 and m2. As to a view direction 610 passing through a vertex, it may be respectively projected to different positions on the near-by reference images of the near-by cameras according the different depth planes m0, m1 and m2. For example, a position of the view direction 610 on the 2D virtual image 607 is (x₀, y₀). This position may correspond to three positions (x_{cl}^{m}, y_{cl}^{m}) on the near-by reference image of the near-by camera C1 due to different projecting depths, wherein m=0, 1 and 2. Similarly, the same position may correspond to three positions (x_{c2}^{m}, y_{c2}^{m}) on the near-by reference image of another near-by camera C2, wherein m=0, 1 and 2. Therefore, the selected near-by reference images may also have three corresponding positions.

Deduced by analogy, if the projecting depth is correct, the individual projected position on the near-by reference image may approximately present to a color of the object. Therefore, if the reference images within an area of the projected positions are approximately the same, a test depth dm of the vertex is then closed to the actual depth. Therefore, as shown in FIG. 8, by comparing the different depths, an optimal depth is then obtained.

Color consistency of near-by reference images may be determined based on a mathematic analysis method. Each vertex has a group of the near-by images corresponding to each test depth. Image differences of the near-by images on an image area of the projected positions may be analysed according to a method, which is not an exclusive method. For example, a correlation parameter rᵢⱼ may be calculated based on the following equation:

$${r}_{ij} = \frac{{\sum }_{k} ( {I}_{jk} - \overline{{I}_{j}} ) ( {I}_{ik} - \overline{{I}_{i}} )}{\sqrt{[ {\sum }_{k} {( {I}_{jk} - \overline{{I}_{j}} )}^{2} ] [ {\sum }_{k} {( {I}_{ik} - \overline{{I}_{i}} )}^{2} ]}} .$$

Wherein i and j represent any two of the near-by reference images, Iᵢₖ and Iⱼₖ are a k-th pixel data within an image area, Īᵢ and Īⱼ are averages of pixel data within the image area. Taking four near-by reference images as an example, there are 6 correlation parameters, and the r value of a forecast depth then may be obtained by averaging the 6 correlation parameters. By comparing the individual r values of all depths, the forecast depth with the maximum r value then is then found. For example, the optimal depth information may be determined according to the average of the 6 correlation parameters or may be determined by comparing a difference degree between the maximum and the minimum values thereof. By such means, the suitable depth of the vertex then may be determined. Deduced by analogy, the suitable depths of all the vertices on the 2D virtual image are calculated.

Referring to FIG. 6 again, if the depth differences of the mesh vertices are too great, it indicates that the corresponding area needs to be finely divided, and the vertex depths thereof may be obtained according to the aforementioned steps, wherein a determination standard is as follow:

$${max}_{p , q ∈ \{ 1 , 2 , 3 \} , p \neq q} \vert {m}_{p} - {m}_{q} \vert > T .$$

Namely, as long as the depth difference of any two of the vertices in a mesh is greater than T, the area is then required to be further divided.

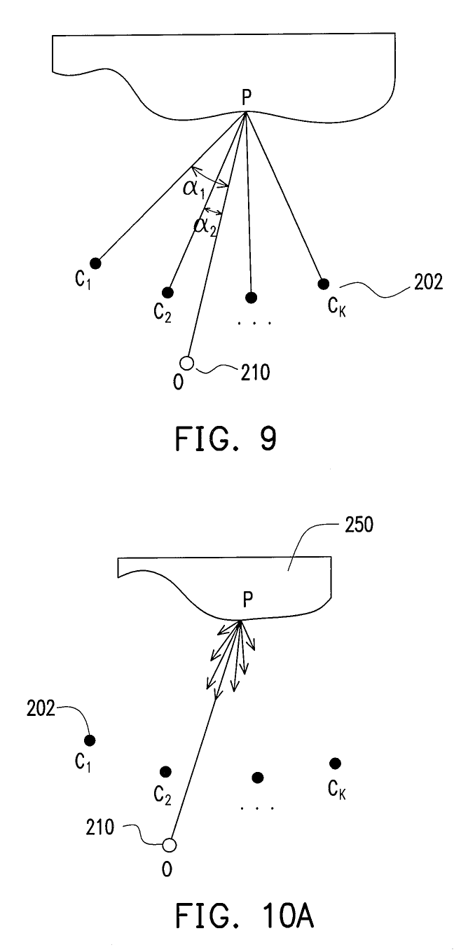

Next, when the depths of vertices are obtained, the vertices are then projected to corresponding positions on the near-by reference images according to the depths for image synthesizing. According to a general computer vision concept, weight of each near-by reference image may be determined, and a main parameter of the weight is an angle formed there between. FIG. 9 is a schematic diagram illustrating angle parameters according to an embodiment of the present invention. Referring to FIG. 9, the viewpoint 210 observes a p point on an object surface, wherein different angles are formed between the p point on the object surface and the viewing angles of different cameras. Generally, the greater the angle is, the more the viewing angle of the camera deviates from the viewpoint 210, and the lower the corresponding weight is.

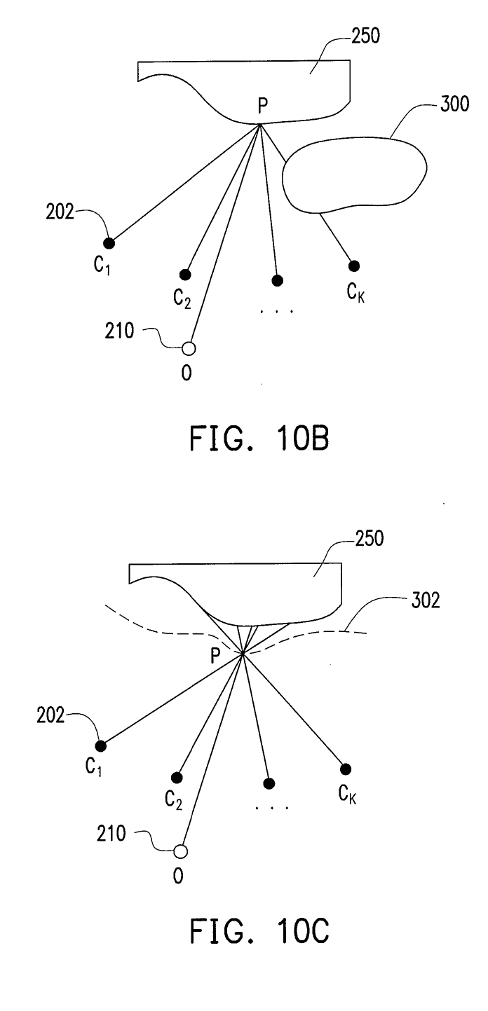

While considering the weights, some other special circumstances should also be considered. FIGS. 10A˜10C are schematic diagrams illustrating some inconsistent circumstances. FIG. 10A illustrates a circumstance that errors are occurred due to a non-lambertian surface of an object 250. FIG. 10B illustrates an occlusion 300. FIG. 10c illustrates a circumstance of non-correct geometric surface forecast. All these circumstances may influence the weights of the near-by images. Based on a present technique of calculating the weights, the aforementioned circumstances are taken into consideration for obtaining the weights of the near-by images.

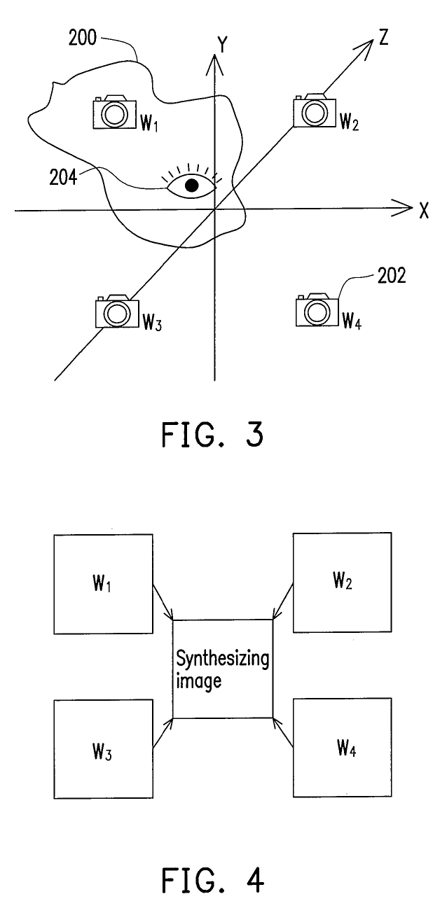

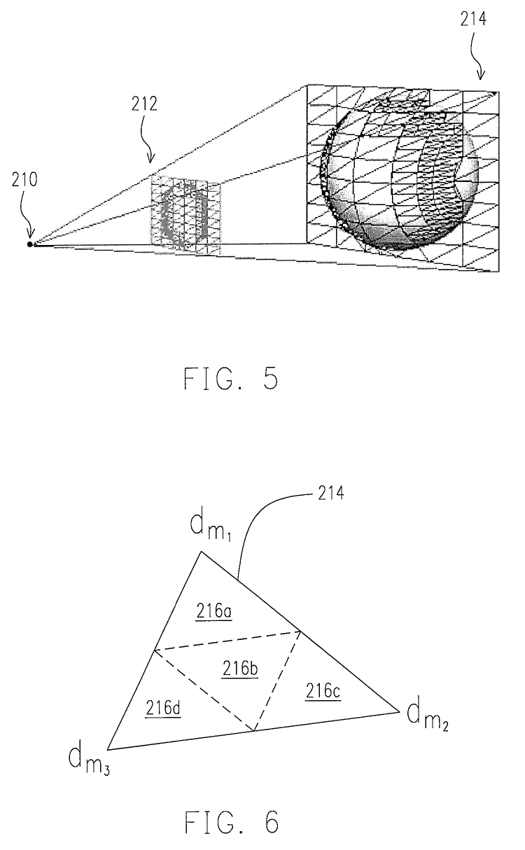

To be specific, FIG. 3 is a schematic diagram illustrating an interpolation mechanism for image synthesizing according to an embodiment of the present invention. Referring to FIG. 3, four reference images are taken as an example, and the four reference images are obtained by capturing an object 200 via four cameras 202 from four different positions. However, there is a viewing angle difference between a viewpoint 204 and the camera 202. The image of the object 200 observed by the viewpoint 204 is generally obtained based on image interpolation of the four reference images. FIG. 4 is a schematic diagram illustrating an interpolation mechanism applied by the present invention. Based on calculation of spatial relations of virtual viewpoints, four weights W1˜W4 are respectively assigned to four reference images. Generally, if all the images are obtained based on interpolation synthesizing, areas with relatively great depth variation may be relatively blurry. In the present embodiment, the image synthesizing may be performed according to two modes. In a first mode, since the camera is within a closed enough range, a position of the camera is rather close to the position and viewing angle of the image to be synthesized. While considering a sharpness of the edge depth thereof, the corresponding image information is directly utilized, and performing of the interpolation is unnecessary.

According to another method, if a single near-by image is within the closed enough range, an image color data thereof then may be directly obtained. If two of the near-by images are within the closed enough range, an image color data of the near-by image with the highest weight then may be obtained. Alternatively, the image color data may be obtained based on an average of the two or more near-by images.

If a second mode is applied, for example, the required image color data may be obtained based on weight interpolation of the near-by images with reference, called multi-texture blending. In other words, the first mode avails maintaining a sharp edge of the image, and the second mode avails image synthesizing of a general area, so as to achieve an optimal synthesizing effect.

After the image view synthesizing method is described, how to perform the parallel processing via a computer system is described. In the present invention, a plurality of different steps for the whole image reconstructing may be simultaneously processed based on a parallel processing method, so as to improve a whole processing efficiency.

When multi arbitrary viewing angel images are reconstructed based on an image-based rendering or a depth-based interpolation technique via computer processing, a plurality of the images captured in different viewing angles is first temporarily stored within a memory of the computer. Next, after necessary initial conditions such as parameters of the camera etc. are set, initial setting of the procedure is then completed.

After initialisation, a viewing angle and a position variation of a user in then obtained via an interactive user interface, so as to calculate relative parameters of a present synthesized image plane. The synthesized image plane is first divided based on a minimum unit of a triangle, for example. In the present embodiment, triangle meshes are taken as an example, although the present invention is not limited thereto.

According to the aforementioned synthesizing mechanism, the vertices of all the triangles are projected into the 3D space according to different depths thereof, and then projected back to the spatial plane of the input images. Then, depth information of all the vertices is obtained by comparing the colors. If the depth differences of the three vertices of a specific triangle are excessive, the triangle then may be divided into four small triangles, and then the aforementioned steps are repeated to obtain the depth information of all the vertices of the triangles. Further fine dividing of the triangle mesh may be referred to as a multi-resolution mesh technique. Finally, the plurality of images captured in different viewing angles are interpolated according to the weights obtained based on the related information such as viewing angle differences, and the user's viewing angle and position etc., so as to obtain the synthesized virtual image corresponding to a present position and viewing angle of the user.

The present invention provides a parallel processing method of multi-resolution mesh technique for reconstructing multi arbitrary viewing angle images. For example, a step of reconstructing the vertex information of the minimum unit of the triangle on the synthesized image plane may be divided into a plurality of groups for parallel processing. In an actual application, the initial triangles may also be divided into a plurality of groups for multi-processing, until all depth information of the vertices on the plane are obtained. Alternatively, each time after the mesh with the same resolution is processed, when a mesh with a next resolution is further divided, the new added triangles are redistributed for balancing an operational burden of each thread. As to the former processing method, after the multi-processing, the new added calculation quantum of each thread may be inconsistent, which may lead to a waste of resources, but this is a convenient way to apply parallel processing As to the latter processing method, each time the multiple threads are restarted or ended, extra resources of the system are consumed. Though the resources of the multiple threads are averaged, extra resources besides the resource required by the algorithm are consumed during restarting and ending of the multiple threads. However, under such circumstance, the whole processing efficiency is still greatly improved.

The present invention is not limited to the aforementioned methods, and other parallel processing method may also be applied to implement the concept of the present invention. In the following content, another embodiment is provided for describing the parallel processing mechanism. FIG. 13 is a schematic diagram illustrating a memory space distribution based on a parallel processing method according to an embodiment of the present invention. Referring to FIG. 13, according to the parallel processing method, the plurality of vertices may be divided into a plurality of vertex groups for processing. In the present embodiment, four groups are taken as an example. Especially, four equivalent groups are taken for processing operations. Therefore, in a memory space 1300 of a system, if the processing thereof is unparallel, a memory space 1300a therein is utilized according to a calculation requirement, and another non-utilized memory space 1300b is allocated for mesh subdivision with maximum amount. For a certain processing stage, such as processing steps required for calculating the depth of each vertex, calculation quantum thereof is huge.

However, according to the parallel processing method, the initial vertices are divided into the plurality of vertex groups, for example, four approximately equivalent vertex groups, and four equivalent memories are assigned thereto for respectively performing the parallel processing. The equivalent memories respectively include utilized memory spaces 1302a, 1304a, 1306a and 1308a, and non-utilized memory spaces 1302b, 1304b, 1306b and 1308b.

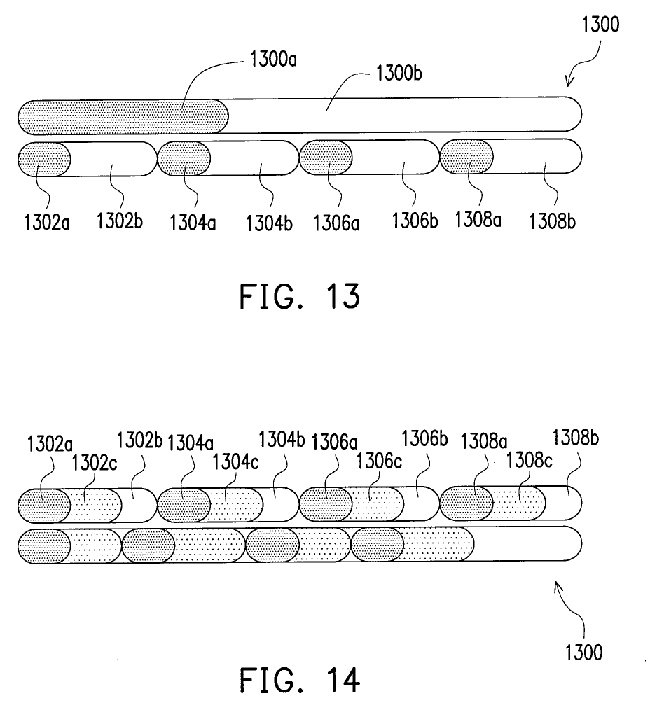

FIG. 14 is a schematic diagram illustrating a memory space distribution based on a parallel processing method according to an embodiment of the present invention. Referring to FIG. 14, when a next stage processing is performed according to the parallel processing method, memory spaces 1302c, 1304c, 1306c and 1308c are respectively further utilized. After the parallel processing is completed, the separated data are then sequentially combined corresponding to a shape of the memory space 1300.

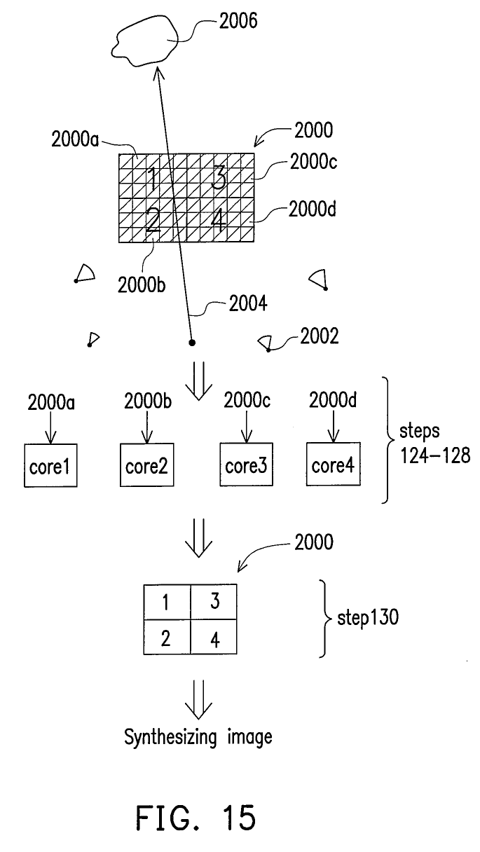

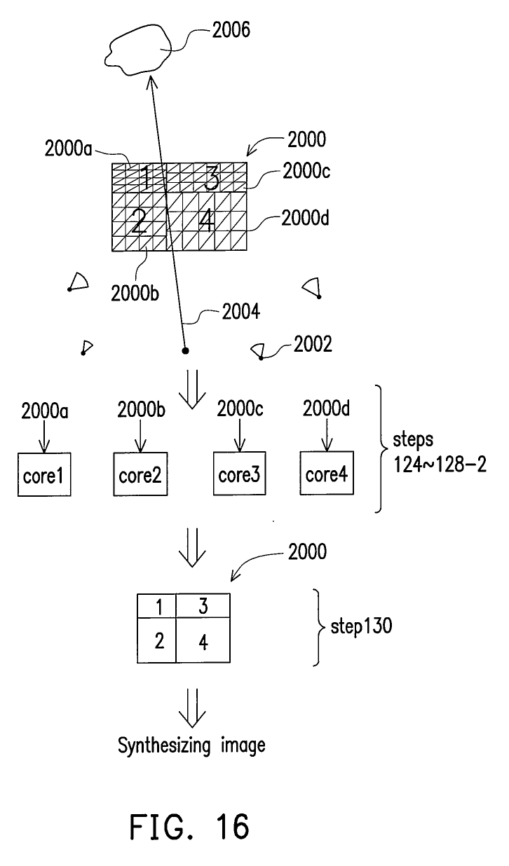

FIG. 15 is a schematic diagram illustrating a parallel processing mechanism applying four cores according to an embodiment of the present invention. Referring to FIG. 15, an image 200 to be generated corresponding to an object 2006 is observed in a view direction 2004, and the meshes thereof are for example, divided into four mesh areas 2000a, 2000b, 2000c and 2000d. A plurality of cameras 2002 near by the view direction 2004 may provide actual captured images of the object 2006. In the present embodiment, the four areas 2000a, 2000b, 2000c and 2000d are properly assigned to the four cores for parallel processing which for example, includes the steps 124-128 shown in FIG. 2 and the memory allocation shown as FIGS. 13-14. In the step 130, separate calculation results of the cores are combined to form a synthesized image. However, there are different arrangements for the parallel processing. For example, as shown in FIG. 16, during the parallel processing, each time processing is performed for a new resolution mesh, the processed units are regrouped for processing, and each time when the processing is completed, processing results thereof are combined, and the processed units are again regrouped for processing of a next resolution mesh, until processing of all multi-resolution mesh is completed, and finally synthesizing is performed.

During the parallel processing, the processed units may also be initially grouped for once, and until the processing is completed, the processing results are then combined for final synthesizing. Besides, during reconstructing of the image plane information, repeated steps of the parallel processing or information of overlapped area are processed and judged for obtaining the correct results.

Besides, for example, after the mesh shown in FIG. 6 is further divided, the aforementioned parallel grouping method may be maintained, or another parallel grouping method may be applied for averaging the calculation quantum of each core.

In the present embodiment, the number of groups required for the parallel processing is further analysed. For example, taking the Intel® Core™2 Quad Q6700 Processor with four-core CPU as an example. Moreover, a library provided by the Microsoft Visual Studio 2005 may also be applied for implementing the multiple threads parallel processing. Table 1 is an efficiency comparison of multiple threads and a single thread.

A. single thread

B. multiple threads (2 threads)

C. multiple threads (3 threads)

D. multiple threads (4 threads)

E. multiple threads (8 threads)

F. multiple threads (12 threads)

TABLE 1

| Rendering process | A | B | C | D | E | F |
|---|---|---|---|---|---|---|
| Construct initial mesh (ms) | 7.4 | 7.02 | 7.27 | 7.31 | 7.17 | 7.35 |
| Reconstruct mesh (ms) | 62.23 | 51.13 | 37.82 | 29.75 | 33.18 | 36.63 |
| Scene Rendering (ms) | 14.95 | 14.44 | 15.03 | 14.58 | 15.05 | 14.42 |
| Overall (ms) | 84.58 | 72.58 | 60.12 | 51.64 | 55.4 | 58.41 |
| Frame per second | 11.82 | 13.78 | 16.63 | 19.36 | 18.05 | 17.12 |

According to the Table 1, when the multiple threads are applied for accelerating, efficiency of the algorithm is improved. Especially in case of 4 threads (D) corresponding to the four-core system being applied for accelerating, the efficiency thereof is improved for 60%. If the threads are continually increased to 8 (E) and 12 (F), as described above, extra resources besides the resource required by the algorithm are consumed during starting or ending of the multiple threads, and therefore efficiencies thereof are not further improved. Moreover, since the triangles may be overlapped on the boundary, and information of the overlapped area needs to be repeatedly processed for obtaining the correct result, processing efficiency of the multiple threads may be reduced. However, results obtained based on the parallel processing are all better than that shown in column A.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A parallel processing method for synthesizing multi-view images, comprising:
inputting a plurality of reference images, wherein each of the reference images is captured corresponding to a reference viewing angle;
determining an intended synthesized image according to a viewpoint and an intended viewing angle;
dividing the intended synthesized image to obtain a plurality of meshes and a plurality of vertices of the meshes, wherein the vertices are divided into a plurality of vertex groups;
generating a suitable spatial depth information corresponding to each of the vertices; and
finding near-by images from the reference images according to the image depths for performing image synthesizing and generating the intended synthesized image, wherein at least one of the aforementioned steps is performed based on parallel processing approach.

2. The parallel processing method for synthesizing multi-view images as claimed in claim 1, wherein the vertex groups comprises 4 groups.

3. The parallel processing method for synthesizing multi-view images as claimed in claim 1, wherein each of the vertex groups is assigned with a memory space for utilization.

4. The parallel processing method for synthesizing multi-view images as claimed in claim 3, further comprising sequentially arranging the assigned memory spaces to form a continuous overall memory.

5. The parallel processing method for synthesizing multi-view images as claimed in claim 1, wherein each of the vertex groups is assigned with an equivalent memory space for utilization.

6. The parallel processing method for synthesizing multi-view images as claimed in claim 1, wherein the near-by images comprise 4 reference images.

7. The parallel processing method for synthesizing multi-view images as claimed in claim 1, wherein the step of generating the plurality of image depth information of the vertices corresponding to the vertex groups comprises steps of parallel processing, which comprising:
forming a view direction according to the viewpoint and each of the vertices;
finding a plurality of near-by images corresponding to each of the vertices from the reference images according to the view direction;
selecting a plurality of possible image depth information;
projecting each of the vertices to a projection position on each of the near-by images according to each of the image depth information; and
analyzing an image difference of the near-by images on an image area of the projected position for determining the image depth information of the vertex.

8. The parallel processing method for synthesizing multi-view images as claimed in claim 7, further comprising determining a region of interest (ROI) corresponding to each of the near-by images according to a set maximum depth and a set minimum depth.

9. The parallel processing method for synthesizing multi-view images as claimed in claim 7, wherein the step of selecting the plurality of possible image depth information comprising:
setting a maximum depth dₘₐₓ and a minimum depth dₘᵢₙ, wherein M depths are divided there between; and
calculating a m-th depth dₘ with an equation of:
$${d}_{m} = \frac{1}{\frac{1}{{d}_{max}} + \frac{m}{M - 1} ( \frac{1}{{d}_{min}} - \frac{1}{{d}_{max}} )} ,$$
wherein m is from 0 to M-1.

10. The parallel processing method for synthesizing multi-view images as claimed in claim 7, wherein in the step of analyzing the image difference of the near-by images on the image area of the projected position, if a difference of the optimal image depths of the vertices of one of the meshes, according to difference analysis, is greater than a setting value, the mesh is then further subdivided into a plurality of relatively small sub meshes, and an optimal image depth of the vertices of the sub meshes is recalculated.

11. The parallel processing method for synthesizing multi-view images as claimed in claim 10, wherein the difference analysis is a difference of any two of the vertices being greater than the setting value, the mesh is then further subdivided.

12. The parallel processing method for synthesizing multi-view images as claimed in claim 10, wherein after the mesh is further subdivided, a former parallel grouping method is maintained, or a new parallel grouping method is applied.

13. The parallel processing method for synthesizing multi-view images as claimed in claim 7, wherein the step of analyzing the image difference of the near-by images on the image area of the projected position comprising considering a correlation parameter rᵢⱼ of the near-by images as:
$${r}_{ij} = \frac{{\sum }_{k} ( {I}_{jk} - \overline{{I}_{j}} ) ( {I}_{ik} - \overline{{I}_{i}} )}{\sqrt{[ {\sum }_{k} {( {I}_{jk} - \overline{{I}_{j}} )}^{2} ] [ {\sum }_{k} {( {I}_{ik} - \overline{{I}_{i}} )}^{2} ]}} ,$$
wherein i and j represent any two of the near-by images, Iᵢₖ and Iⱼₖ represent a k-th pixel data within the image area, and Īᵢ and Īⱼ represent averages of the pixel data within the image area.

14. The parallel processing method for synthesizing multi-view images as claimed in claim 1, wherein in a first mode, if a single near-by image is closed enough, an image color data is then directly obtained for synthesizing the intended synthesized image.

15. The parallel processing method for synthesizing multi-view images as claimed in claim 1, wherein in the first mode, if two or more near-by images are closed enough, an image color data of the near-by image with the highest weight is then obtained.

16. The parallel processing method for synthesizing multi-view images as claimed in claim 1, wherein in the first mode, if two or more near-by images are closed enough, an image color data is then obtained according to an average of the two or more near-by images.

17. The parallel processing method for synthesizing multi-view images as claimed in claim 1, wherein in a second mode, an image color data is obtained according to a weight interpolation of the near-by images.

18. The parallel processing method for synthesizing multi-view images as claimed in claim 1, wherein the first mode is determined by checking a difference degree between a maximum weight and a secondary maximum weight of the near-by images of the vertex, and if a result thereof is greater than a threshold value, the first mode is applied, or otherwise the second mode is applied.

19. The parallel processing method for synthesizing multi-view images as claimed in claim 17, wherein the maximum weight and the secondary maximum weight are values after normalization.

20. The parallel processing method for synthesizing multi-view images as claimed in claim 1, wherein shapes of the meshes are calculating by triangles.

21. A parallel processing method for synthesizing multi-view images, comprising:
initially setting an intended synthesized image corresponding to an intended viewing angle;
dividing the intended synthesized image to obtain a plurality of meshes and a plurality of vertices of the meshes;
finding a plurality of near-by reference images of each of the vertices;
calculating an image depth information of each of the vertices according to the near-by reference images; and
synthesizing the intended synthesized image according to the reconstructed image depth information of each of the vertices,
wherein after the step of dividing the intended synthesized image, processing results are combined after a plurality of parallel processing threads divided within a single processing stage is completed, or a plurality of processing stages is divided, and the processing results are combined after the plurality of parallel processing threads of each stage is completed.

22. The parallel processing method for synthesizing multi-view images as claimed in claim 21, wherein after each of the processing stages is completed, an integrated vertex image information corresponding to the intended synthesized image is combined.

23. The parallel processing method for synthesizing multi-view images as claimed in claim 21, further comprising during combining of the intended synthesized image, the meshes information of a repeated area or an overlapped area between a plurality of results generated based on the parallel processing are further judged and processed.

24. The parallel processing method for synthesizing multi-view images as claimed in claim 21, wherein each time after the parallel processing threads are divided and the processing results are combined, for a next dividing of the parallel processing threads, a former parallel grouping method is maintained, or a new parallel grouping method is applied.

25. The parallel processing method for synthesizing multi-view images as claimed in claim 21, wherein if a difference of any two of the vertices is greater than the setting value, the mesh is then further divided.

26. The parallel processing method for synthesizing multi-view images as claimed in claim 25, wherein after the mesh is further divided, a former parallel grouping method is maintained, or a new parallel grouping method is applied.

27. The parallel processing method for synthesizing multi-view images as claimed in claim 21, further comprising reconstructing of an image plane information from the reconstructed image depth information, wherein the repeated steps of the parallel processing or the information of overlapped areas is processed and judged for obtaining the correct results.
